(19) United States
(12) Patent Application Publication
(10) Pub. No.: US 2006/0231693 A1
(43) Pub. Date: Oct. 19, 2006

(54) Orientation adjusting device for a satellite antenna

(76) Inventors: Hung-Yuan Lin, Taipei Hsien (TW); Bin-Chieh Kao, Taipei Hsien (TW)

Correspondence Address: TROP PRUNER & HU, PC, 1616 S. VOSS ROAD, SUITE 750, HOUSTON, TX, 77057-2631, US

(21) Appl. No.: 11/328,936

(22) Filed: Jan. 10, 2006

(30) Foreign Application Priority Data
Feb. 16, 2005 (TW) 094104451

(51) Int. Cl. F16L 3/00

(52) U.S. Cl. 248/121

(57) ABSTRACT

An orientation adjusting device includes a base unit, a bracket unit, and an angle-adjusting mechanism. The bracket unit is coupled pivotally to the base unit, and includes a pair of parallel plates. The angle-adjusting mechanism serves to adjust an angular position of the bracket unit relative to the base unit, and includes a pivot unit and a pivot joint. The pivot joint interconnects the plates of the bracket unit and the first rotatable unit so as to permit rotation of the first rotatable unit relative to the bracket unit about a first horizontal axis. The first pivot joint has an enlarged head that abuts against one of the plates of the bracket unit, and a shank that extends from the enlarged head and that is formed with a shoulder abutting against the other one of the plates of the bracket unit.

### CROSS-REFERENCE TO RELATED APPLICATION

This application claims priority of Taiwanese application no. 094104451, filed on Feb. 16, 2005.

### BACKGROUND OF THE INVENTION

1. Field of the Invention

This invention relates to an orientation adjusting device, and more particularly to an orientation adjusting device for a satellite antenna capable of fine tuning inclined and azimuth angles of the satellite antenna.

2. Description of the Related Art

A conventional satellite antenna orientation adjusting device includes a base unit, a bracket unit, and a pivot joint that interconnects the base unit and the bracket unit and that permits relative rotation between the base unit and the bracket unit. An antenna that includes a receiver is mounted on the bracket unit of the conventional orientation adjusting device.

In operation, when adjusting the orientation of the satellite antenna, the bracket unit is rotated at a desired angular position relative to the base unit. Thereafter, the bracket unit is fastened to the base unit with the use of screw fasteners so as to retain the bracket unit at the desired angular position.

The aforementioned conventional orientation adjusting device is disadvantageous in that the screw fasteners must loosened and tightened each time the satellite antenna is reoriented. Such a process is inconvenient, time consuming, and prone to error.

### SUMMARY OF THE INVENTION

Therefore, the object of the present invention is to provide an orientation adjusting device that is capable of overcoming the aforesaid drawback of the prior art.

According to one aspect of the present invention, an orientation adjusting device comprises a base unit, a bracket unit, and an angle-adjusting mechanism. The bracket unit is coupled pivotally to the base unit, and includes a pair of parallel plates. The angle-adjusting mechanism serves to adjust an angular position of the bracket unit relative to the base unit, and includes first and second rotatable units, a pivot joint, and a telescopic unit. The first rotatable unit includes a tubular member. The pivot joint interconnects the plates of the bracket unit and the tubular member of the first rotatable unit so as to permit rotation of the tubular member of the first rotatable unit relative to the bracket unit about a first horizontal axis. The second rotatable unit is coupled pivotally to the base unit, and is pivotable relative to the base unit about a second horizontal axis parallel to the first horizontal axis. The telescopic unit interconnects the first and second rotatable units, and is operable so as to vary the distance between the second and third horizontal axes, thereby adjusting the angular position of the bracket unit relative to the base unit. The first pivot joint has an enlarged head that abuts against one of the plates of the bracket unit, and a shank that extends from the enlarged head and that is formed with a shoulder abutting against the other one of the plates of the bracket unit so as to fix the distance between the plates of the bracket unit. The tubular member of the first rotatable unit is sleeved on the shank of the pivot joint.

According to another aspect of the present invention, an apparatus comprises an orientation adjusting device and an antenna. The orientation adjusting device includes a base unit, a bracket unit, and an angle-adjusting mechanism. The bracket unit is coupled pivotally to the base unit, and includes a pair of parallel plates. The angle-adjusting mechanism serves to adjust an angular position of the bracket unit relative to the base unit, and includes first and second rotatable units, a pivot joint, and a telescopic unit. The first rotatable member includes a tubular member. The pivot joint interconnects the plates of the bracket unit and the tubular member of the first rotatable unit so as to permit rotation of the tubular member of the first rotatable unit relative to the bracket unit about a first horizontal axis. The second rotatable unit is coupled pivotally to the base unit, and is pivotable relative to the base unit about a second horizontal axis parallel to the first horizontal axis. The telescopic unit interconnects the first and second rotatable units, and is operable so as to vary the distance between the second and third horizontal axes, thereby adjusting the angular position of the bracket unit relative to the base unit. The first pivot joint has an enlarged head that abuts against one of the plates of the bracket unit, and a shank that extends from the enlarged head and that is formed with a shoulder abutting against the other one of the plates of the bracket unit so as to fix the distance between the plates of the bracket unit. The tubular member of the first rotatable unit is sleeved on the shank of the pivot joint. The antenna is mounted on the bracket unit of the orientation adjusting device.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view of the preferred embodiment of an orientation adjusting device of an apparatus according to the present invention;

FIG. 2 is an exploded perspective view of the preferred embodiment;

FIG. 3 is a sectional view illustrating a pivot joint of the preferred embodiment;

FIG. 4 is a perspective view to illustrate an insert of the preferred embodiment; and

FIG. 5 is a schematic view to illustrate operation of an angle-adjusting mechanism of the preferred embodiment.

### DETAILED DESCRIPTION OF THE PREFERRED EMBODIMENT

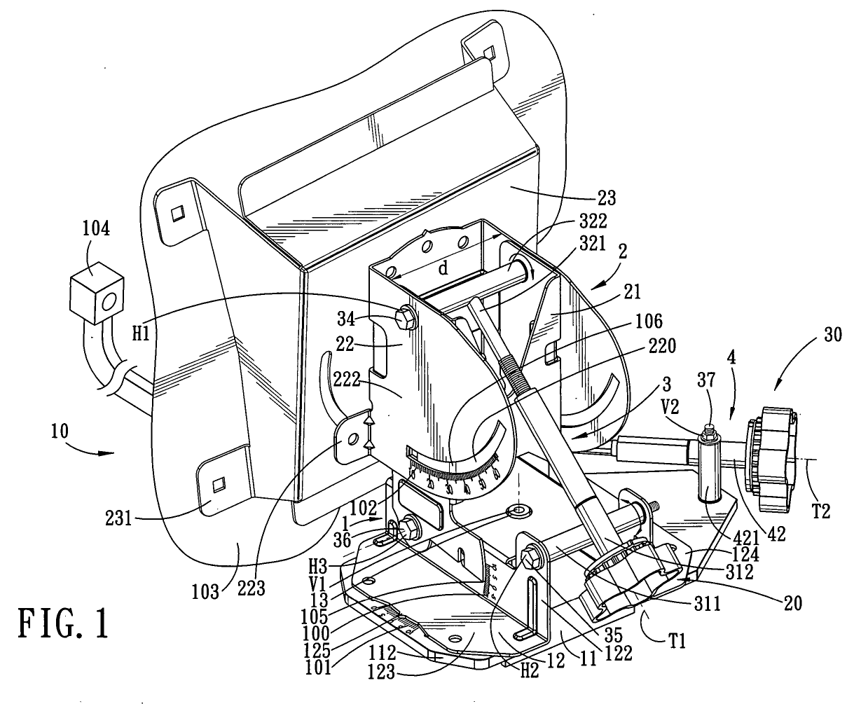

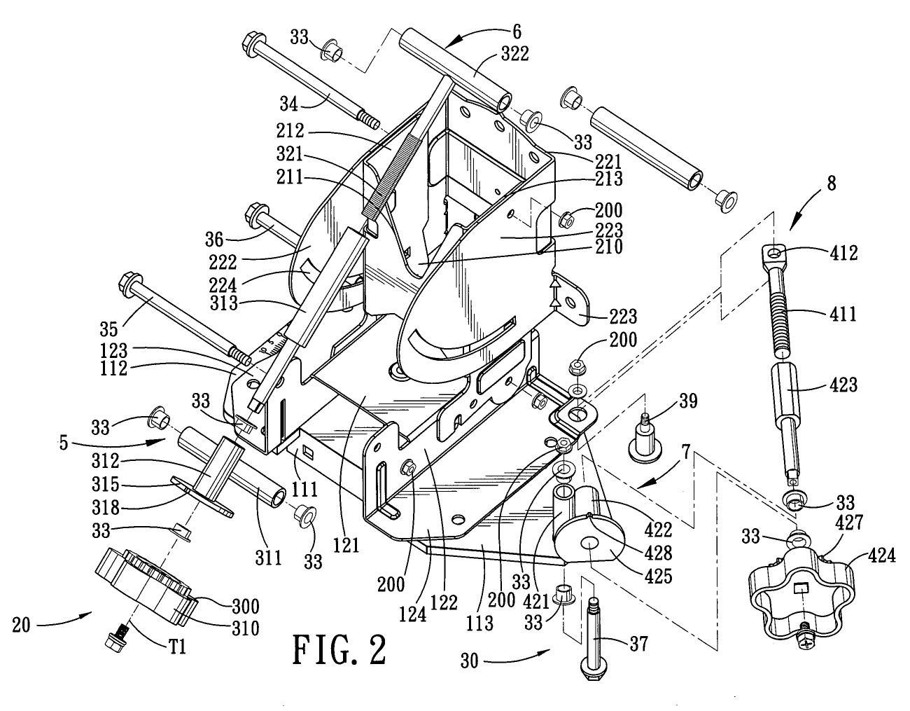

Referring to FIGS. 1 and 2, the preferred embodiment of an orientation adjusting device of an apparatus according to the present invention is shown to include a base unit 1, a bracket unit 2, and a first angle-adjusting mechanism 20.

The apparatus includes an antenna 10, such as a satellite antenna, that is mounted on the orientation adjusting device. The antenna 10 includes a disc reflector 103 and an LNBF (low noise block with integrated feed) 104.

The orientation adjusting device of this embodiment serves to adjust the orientation of the antenna 10 in a manner that will be described hereinafter.

The base unit 1 includes a first base member 12 that includes a pair of parallel left and right vertical plates 122, an intermediate horizontal plate 121 that interconnects the left and right vertical plates 122 of the first base member 12 of the base unit 1, and a pair of left and right horizontal plates 123, 124, each of which extends outwardly from a respective one of the left and right vertical plates 122 of the first base member 12 of the base unit 1.

The bracket unit 2 is coupled pivotally to the base unit 1, and includes a first bracket member 21 that, in turn, includes a pair of parallel left and right plates 212, 213, each of which has upper and lower end portions, and an interconnecting plate 211 interconnecting the upper end portions of the left and right plates 212, 213 of the first bracket member 21 of the bracket unit 2.

The first angle-adjusting mechanism 20 serves to adjust the angular position of the bracket unit 2 relative to the base unit 1 in a vertical plane. In this embodiment, the first angle-adjusting mechanism 20 includes first and second rotatable units 6, 5, first and second pivot joints 34, 35, and a first telescopic unit 3.

The first pivot joint 34 interconnects the upper end portions of the left and right plates 212, 213 of the first bracket member 21 of the bracket unit 2 and the first rotatable unit 6 so as to permit rotation of the first rotatable unit 6 relative to the first bracket member 21 of the bracket unit 2 about a first horizontal axis (H1).

In this embodiment, the first rotatable unit 6 includes a tubular member 322 that is disposed between the left and right plates 212, 213 of the first bracket member 21 of the bracket unit 2 and that is sleeved rotatably on the first pivot joint 34.

The second pivot joint 35 interconnects the left and right vertical plates 122 of the first base member 12 of the base unit 1 and the second rotatable unit 5 so as to permit rotation of the second rotatable unit 5 relative to the first base member 12 of the base unit 1 about a second horizontal axis (H2) parallel to the first horizontal axis (H1).

The orientation adjusting device further includes a third pivot joint 36 that interconnects the left and right vertical plates 122 of the first base member 12 of the base unit 1 and the lower end portions of the left and right plates 212, 213 of the first bracket member 21 of the bracket unit 2 so as to permit rotation of the bracket unit 2 relative to the base unit 1 about a third horizontal axis (H3) parallel to the first and second horizontal axes (H1, H2).

In this embodiment, the second rotatable unit 5 includes a first tubular member 311 that is disposed between the left and right vertical plates 122 of the first base member 12 of the base unit 1, and that is sleeved rotatably on the second pivot joint 35.

The first telescopic unit 3 interconnects the tubular member 322 of the first rotatable unit 6, and the first tubular member 311 of the second rotatable unit 5, and is operable so as to vary the distance between the first and second horizontal axes (H1, H2). Therefore, the first telescopic unit 3 is able to adjust the angular position of the first bracket member 21 of the bracket unit 2 relative to the first base member 12 of the base unit 1 in the vertical plane.

In this embodiment, the first telescopic unit 3 includes first and second telescopic members 321, 313.

The first telescopic member 321 of the first telescopic unit 3 has a connecting end portion that is connected securely to a midpoint of the tubular member 322 of the first rotatable unit 6, and a threaded end portion that is opposite to the connecting end portion and that is formed with an outer thread.

The second telescopic member 313 of the first telescopic unit 3 is coupled rotatably to the second rotatable unit 5. In particular, the second rotatable unit 5 further includes a second tubular member 312 that is connected securely and transversely to the first tubular member 311 of the second rotatable unit 5, and that has an end provided with a radially extending flange 315. The second telescopic member 313 of the first telescopic unit 3 has an actuating end portion, and a threaded end portion that is opposite to the actuating end portion, that is formed with an inner thread (not shown), that is inserted rotatably through the second tubular member 312 of the second rotatable unit 5, and that is threadedly coupled to the threaded end portion of the first telescopic member 321 of the first telescopic unit 3. The second telescopic member 313 of the first telescopic unit 3 is rotatable relative to the second tubular member 312 of the second rotatable unit 5 about a first transverse axis (T1) transverse to the first and second horizontal axes (H1, H2).

It is noted that the interconnecting plate 211 of the first bracket member 21 of the bracket unit 2 is formed with a V-shaped groove 210 through which the first telescopic unit 3 extends for interconnecting the first and second rotatable units 6, 5.

The first telescopic unit 3 further includes an operable member 310 that is connected securely to the actuating end portion of the second telescopic member 313 of the first telescopic unit 3, and that abuts against the flange 315 on the second tubular member 311 of the second rotatable unit 5. The operable member 310 is operable so as to drive rotation of the second telescopic member 313 of the first telescopic unit 3 to result in axial displacement of the first telescopic member 321 of the first telescopic unit 3 along the first transverse axis (T1) to thereby vary the distance between the second and third horizontal axes (H2, H3).

The bracket unit 2 further includes a second bracket member 22 that is generally U-shaped, and includes a pair of parallel left and right plates 222, 223, and an interconnecting plate 221 that interconnects the left and right plates 222, 223 of the second bracket member 22 of the bracket unit 2.

The first pivot joint 34 interconnects the upper end portions of the left and right plates 212, 213 of the first bracket member 21 of the bracket unit 2 and the left and right plates 222, 223 of the second bracket member 22 of the bracket unit 2 so as to permit rotation of the second bracket member 22 relative to the first bracket member 21 about the first horizontal axis (H1).

The bracket unit 2 further includes a third bracket member 23 on which the antenna 10 is mounted. The third bracket 23 of the bracket unit 2 includes a mounting plate that is generally rectangular and that is mounted on the interconnecting plate 221 of the second bracket member 22 of the bracket unit 2.

It is noted that, as illustrated in FIG. 1, the left vertical plate 122 of the first base member 12 of the base unit 1 is marked with graduations 100. The lower end portion of the left plate 212 of the first bracket member 21 of the bracket unit 2 is provided with a pointer 105. The graduations 100 and the pointer 105 cooperatively form an angle indicator for indicating the angular position of the first bracket member 21 of the bracket unit 2 relative to the first base member 12 of the base unit 1. Moreover, the operable member 310 of the first telescopic unit 3 has a periphery that is marked with graduations 300. The flange 315 on the second tubular member 312 of the first rotatable unit 5 is provided with a pointer 318. The graduations 300 and the pointer 318 cooperatively form an angle indicator for indicating the angular position of the first telescopic member 313 of the first telescopic unit 3 relative to the second tubular member 312 of the first rotatable unit 5. Further, the left plate 222 of the second bracket member 22 of the bracket unit 2 is formed with a curved window 220 therethrough, and is marked with graduations 102 adjacent to the window 220. The upper end portion of the left plate 212 of the first bracket member 21 of the bracket unit 2 is provided with a pointer 106 that is registered with the window 220. The graduations 102 and the pointer 106 on the upper end portion of the left plate 212 of the first bracket member 21 of the bracket unit 2 cooperatively form an angle indicator for indicating angular position of the second bracket member 22 relative to the first bracket member 21.

The base unit 1 further includes a second base member 11 that has left and right end portions 112, 113, and an intermediate portion 111 interconnecting the left and right end portions 112, 113. The first base member 12 is disposed on the second base member 11.

The orientation adjusting device further includes a fourth pivot joint 13 that interconnects the intermediate horizontal plate 121 of the first base member 12 and the intermediate portion 111 of the second base member 11 so as to permit rotation of the first base member 12 relative to the second base member 11 about a first vertical axis (V1).

It is noted that, as illustrated in FIG. 1, the left end portion 112 of the second base member 11 of the base unit 1 is marked with graduations 101. The left horizontal plate 123 of the first base member 12 of the base unit is provided with a pointer 125. The graduations 101 and the pointer 125 cooperatively form an angle indicator for indicating the angular position of the first base member 12 relative to the second base member 11.

The orientation adjusting device further includes a second angle-adjusting mechanism 30 that serves to adjust the angular position of the first base member 12 relative to the second base member 11 in a horizontal plane. In this embodiment, the second angle-adjusting mechanism 30 includes third and fourth rotatable units 7, 8, fifth and sixth pivot joints 37, 39, and a second telescopic unit 4.

The fifth pivot joint 37 interconnects the right end portion 113 of the second base member 11 of the base unit 1 and the third rotatable unit 7 so as to permit rotation of the third rotatable unit 7 relative to the second base member 11 of the base unit 1 about a second vertical axis (V2) parallel to the first vertical axis (V1).

In this embodiment, the third rotatable unit 7 includes a first tubular member 421 that is sleeved rotatably on the fifth pivot joint 37.

The sixth pivot joint 39 interconnects the right horizontal plate 124 of the first base member 12 of the base unit 1 and the fourth rotatable unit 8 so as to permit rotation of the fourth rotatable unit 8 relative to the right horizontal plate 124 of the first base member 12 of the base unit 1 about a third vertical axis (V3) parallel to the first and second vertical axes (V1, V2).

In this embodiment, the fourth rotatable unit 8 includes a hole-defining piece 412 that is sleeved on the sixth pivot joint 39.

The second telescopic unit 4 interconnects the first tubular member 421 of the third rotatable unit 7 and the hole-defining piece 412 of the fourth rotatable unit 8, and is operable so as to vary the distance between the second and third vertical axes (V2, V3), thereby adjusting angular position of the first base member 12 relative to the second base member 11 in the horizontal plane.

In this embodiment, the second telescopic unit 4 includes first and second telescopic members 423, 411. The first telescopic member 423 of the second telescopic unit 4 is coupled rotatably to the third rotatable unit 7. In particular, the third rotatable unit 7 further includes a second tubular member 422 that is connected securely and transversely to the first tubular member 421 of the third rotatable unit 7, and that has an end provided with a radially extending flange 425. The first telescopic member 423 of the second telescopic unit 4 has an actuating end portion, and a threaded end portion that is opposite to the actuating end portion, that is formed with an inner thread (not shown), and that is inserted rotatably through the second tubular member 422 of the third rotatable unit 7. The first telescopic member 423 of the second telescopic unit 4 is rotatable relative to the second tubular member 422 of the third rotatable unit 7 about a second transverse axis (T2) transverse to the second and third vertical axes (V2, V3). The second telescopic member 411 of the second telescopic unit 4 has a connecting end portion that is connected securely to the hole-defining piece 412 of the fourth rotatable unit 8, and a threaded end portion that is opposite to the connecting end portion, that is formed with an outer thread, and that is threadedly coupled to the threaded end portion of the first telescopic member 423 of the second telescopic unit 4.

The second telescopic unit 4 further includes an operable member 424 that is connected securely to the actuating end portion of the first telescopic member 423 of the second telescopic unit 4, that abuts against the flange 425 of the second tubular member 422 of the third rotatable unit 7, and that is operable so as to drive rotation of the first telescopic member 423 of the second telescopic unit 4 to result in axial displacement of the second telescopic member 411 of the second telescopic unit 4 along the second transverse axis (T2) to thereby vary the distance between the second and third vertical axes (V2, V3).

Since the construction of the first to sixth pivot joints 34, 35, 36, 13, 37, 39 are the same, only the first pivot joint 34 will be described hereinbelow.

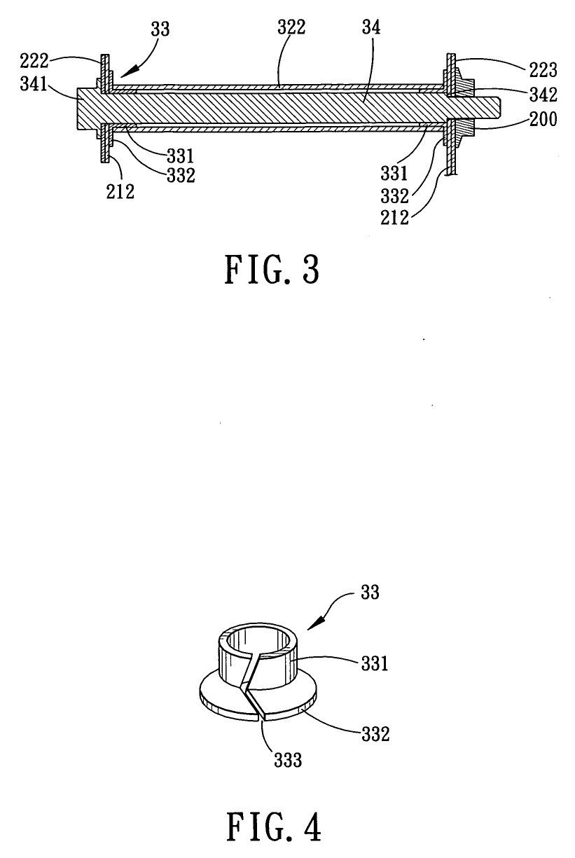

With further reference to FIG. 3, the first pivot joint 34 has an enlarged head 341, a shank that extends from the enlarged head 341 and that is formed with a shoulder 342, and a threaded end portion that extends from the shoulder 342 and that is formed with an outer thread. When the first pivot joint 34 interconnects the first and second bracket members 21, 22 of the bracket unit 2, the enlarged head 341 of the first pivot joint 34 abuts against the left plate 222 of the second bracket member 21, the shoulder 342 of the first pivot joint 34 abuts against the right plate 213 of the first bracket member 21, and the threaded end portion of the first pivot joint 34 extends through the right plate 213 of the first bracket member 21 and the right plate 223 of the second bracket member 22. As such, the distance (d) between the left plate 222 of the second bracket member 22 and the right plate 213 of the first bracket member of the bracket unit is fixed. The first pivot joint 34 is retained with the use of a nut 200 in a known manner.

It is noted that, as illustrated in FIG. 2, the operable member 424 of the second telescopic unit 4 has a periphery that is marked with graduations 427. The flange 425 on the second tubular member 422 of the third rotatable unit 7 is provided with a pointer 428. The graduations 427 and the pointer 428 cooperatively form an angle indicator for indicating the angular position of the first telescopic member 423 of the second telescopic unit 4 relative to the second tubular member 422 of the third rotatable unit 7.

The orientation adjusting device further includes a plurality of inserts 33. Since the construction and usage of the inserts 33 are the same, only the inserts 33 used in the second rotatable unit 6 will be described hereinbelow.

It is noted herein that when the tubular member 322 of the first rotatable unit 6 is sleeved on the first pivot joint 34, gaps (not shown) are formed between an end of the tubular member 322 of the first rotatable unit 6 and the left plate 212 of the first bracket member 21 of the bracket unit 2, between an opposite end of the tubular member 322 of the first rotatable unit 6 and the right plate 213 of the first bracket member 21 of the bracket unit 2, between the end of the tubular member 322 of the first rotatable unit 6 and the first pivot joint 34, and between the opposite end of the tubular member 322 of the first rotatable unit 6 and the first pivot joint. The inserts 33 are used for filling the gaps.

As illustrated in FIG. 4, each of the inserts 33 includes an annular wall 331, and a peripheral flange 332 that extends radially and outwardly from an end of the annular wall 331. In this embodiment, each of the inserts 33 is made from a plastic material. In an alternative embodiment, each of the inserts 33 is made from metal. In use, the annular wall 331 of each of the inserts 33 is sleeved on a respective one of ends of the first pivot joint 34, and is inserted into a respective one of the ends of the tubular member 322 of the first rotatable unit 6. As such, the peripheral flange 332 of each of the inserts 33 is disposed between and abuts against a respective one of the ends of the tubular member 322 of the first rotatable unit 6 and a respective one of the left and right plates 212, 213 of the first bracket member 21 of the bracket unit 2. Preferably, each of the inserts 33 is formed with a slit 333 for facilitating insertion of the annular wall 331 into the tubular member 322 of the first rotatable unit 6.

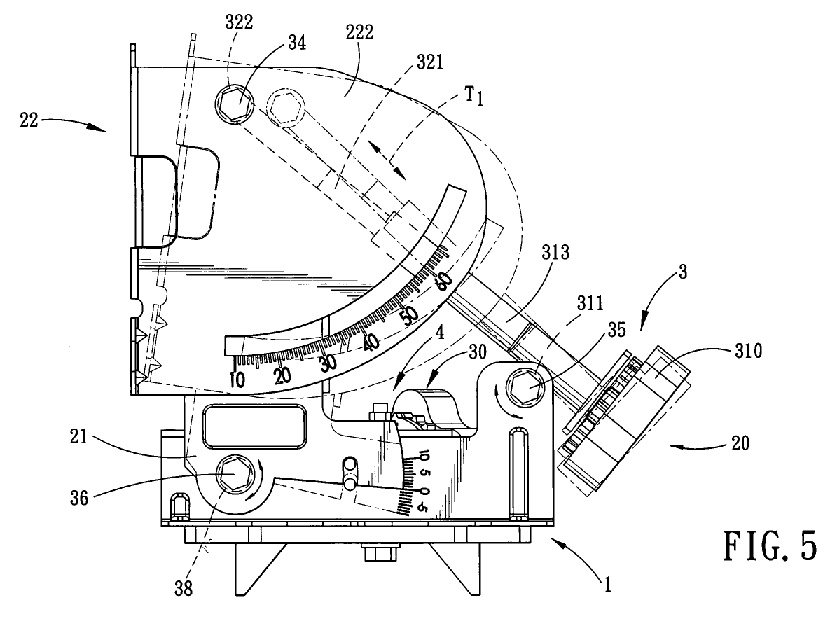

In operation, as illustrated in FIG. 5, when adjusting the inclined angle of the antenna 10 (see FIG. 1), the second bracket member 22 may be first rotated to a desired angular position relative to the first bracket member 21. The operable member 310 of the first telescopic unit 3 is then operated to drive rotation of the second telescopic member 313 of the first telescopic unit 3. The rotation of the second telescopic member 313 of the first telescopic unit 3 results in the axial displacement of the first telescopic member 321 of the first telescopic unit 3 along the first transverse axis (T1), which, in turn, adjusts the angular position of the bracket unit 2 relative to the base unit 1 in the vertical plane. Moreover, with reference to FIGS. 1 and 2, when adjusting the azimuth angle of the antenna 10, the operable member 424 of the second telescopic unit 4 is operated to drive rotation of the first telescopic member 423 of the second telescopic unit 4. The rotation of the first telescopic member 423 of the second telescopic unit 4 results in the axial displacement of the second telescopic member 411 of the second telescopic unit 4 along the second transverse axis (T2), which, in turn, adjusts the angular position of the first base member 12 relative to the second base member 11 in the horizontal plane.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An orientation adjusting device, comprising:
a base unit;
a bracket unit coupled pivotally to said base unit, and including a pair of parallel plates; and
an angle-adjusting mechanism for adjusting an angular position of said bracket unit relative to said base unit, said angle-adjusting mechanism including
a first rotatable unit that includes a tubular member,
a first pivot joint that interconnects said plates of said bracket unit and said tubular member of said first rotatable unit so as to permit rotation of said tubular member of said first rotatable unit relative to said bracket unit about a first horizontal axis,
a second rotatable unit that is coupled pivotally to said base unit, and is pivotable relative to said base unit about a second horizontal axis parallel to the first horizontal axis, and
a telescopic unit that interconnects said first and second rotatable units, and that is operable so as to vary the distance between the second and third horizontal axes, thereby adjusting the angular position of said bracket unit relative to said base unit,
wherein said first pivot joint has an enlarged head that abuts against one of said plates of said bracket unit, and a shank that extends from said enlarged head and that is formed with a shoulder abutting against the other one of said plates of said bracket unit so as to fix the distance between said plates of said bracket unit, and
wherein said tubular member of said first rotatable unit is sleeved on said shank of said first pivot joint.

2. The orientation adjusting device as claimed in claim 1, wherein said base unit includes a pair of parallel vertical plates,
said first angle-adjusting device further including a second pivot joint that interconnects said plates of said base unit and said second rotatable unit so as to permit rotation of said second rotatable unit relative to said base unit about the second horizontal axis.

3. The orientation adjusting device as claimed in claim 2, wherein said second rotatable unit includes a tubular member that is sleeved on said second pivot joint.

4. The orientation adjusting device as claimed in claim 1, wherein said telescopic unit includes
a first telescopic member that is coupled securely to said tubular member of said first rotatable unit, and
a second telescopic member that is coupled rotatably to said second rotatable unit and that is coupled threadedly to said first telescopic member, said second telescopic member being rotatable relative to said second rotatable unit about a transverse axis transverse to the first and second horizontal axes,
wherein rotation of said second telescopic member about the transverse axis results in axial displacement of said first telescopic member along the transverse axis.

5. The orientation adjusting device as claimed in claim 1, wherein said tubular member of said first rotatable unit has opposite ends, said first pivot joint having opposite ends,
said orientation adjusting device further comprising a pair of inserts, each of which includes an annular wall that is sleeved on a respective one of said ends of said first pivot joint and that is inserted into a respective one of said ends of said tubular member of said first rotatable unit, and a peripheral flange that extends radially and outwardly from said annular wall, and that is disposed between a respective one of said ends of said tubular member of said first rotatable unit and a respective one of said plates of said bracket unit.

6. The orientation adjusting device as claimed in claim 4, wherein said telescopic unit further includes an operable member coupled to said second telescopic member and operable so as to drive rotation of said second telescopic member.

7. An apparatus, comprising:
an orientation adjusting device including
a base unit,
a bracket unit coupled pivotally to said base unit, and including a pair of parallel plates, and
an angle-adjusting mechanism for adjusting an angular position of said bracket unit relative to said base unit, said angle-adjusting mechanism including
a first rotatable unit that includes a tubular member,
a first pivot joint that interconnects said plates of said bracket unit and said tubular member of said first rotatable unit so as to permit rotation of said tubular member of said first rotatable unit relative to said bracket unit about a first horizontal axis,
a second rotatable unit that is coupled pivotally to said base unit, and is pivotable relative to said base unit about a second horizontal axis parallel to the first horizontal axis, and
a telescopic unit that interconnects said first and second rotatable units, and that is operable so as to vary the distance between the second and third horizontal axes, thereby adjusting the angular position of said bracket unit relative to said base unit,
wherein said first pivot joint has an enlarged head that abuts against one of said plates of said bracket unit, and a shank that extends from said enlarged head and that is formed with a shoulder abutting against the other one of said plates of said bracket unit so as to fix the distance between the plates of the bracket unit; and
an antenna mounted on said bracket unit of said orientation adjusting device.

8. The apparatus as claimed in claim 7, wherein said base unit includes a pair of parallel vertical plates,
said first angle-adjusting device further including a second pivot joint that interconnects said plates of said base unit and said second rotatable unit so as to permit rotation of said second rotatable unit relative to said base unit about the second horizontal axis.

9. The apparatus as claimed in claim 8, wherein said second rotatable unit includes a tubular member that is sleeved on said second pivot joint.

10. The apparatus as claimed in claim 9, wherein said telescopic unit includes
a first telescopic member that is coupled securely to said tubular member of said first rotatable unit, and
a second telescopic member that is coupled rotatably to said second rotatable unit and that is coupled threadedly to said first telescopic member, said second telescopic member being rotatable relative to said second rotatable unit about a transverse axis transverse to the first and second horizontal axes,
wherein rotation of said second telescopic member about the transverse axis results in axial displacement of said first telescopic member along the transverse axis.

11. The apparatus as claimed in claim 7, wherein said tubular member of said first rotatable unit has opposite ends, said shank of said first pivot joint having opposite ends,
said orientation adjusting device further including a pair of inserts, each of which includes an annular wall that is sleeved on a respective one of said ends of said shank of said first pivot joint and that is inserted into a respective one of said ends of said tubular member of said first rotatable unit, and a peripheral flange that extends radially and outwardly from said annular wall, and that is disposed between a respective one of said ends of said tubular member of said first rotatable unit and a respective one of said plates of said bracket unit.

12. The apparatus as claimed in claim 10, wherein said telescopic unit further includes an operable member coupled to said second telescopic member and operable so as to drive rotation of said second telescopic member.
